(19) United States
(12) Patent Application Publication
(10) Pub. No.: US 2015/0095128 A1
(43) Pub. Date: Apr. 2, 2015

(54) IN-STORE CUSTOMER ENGAGEMENT SYSTEMS AND METHODS

(71) Applicant: Capillary Technologies International Pte Ltd., Singapore (SG)

(72) Inventors: Krishna Kumar Mehra, Kolkata (IN); Naveen Athresh, Bangalore (IN); Kedar Prakash Chandrayan, Bangalore (IN); Saurabh Kumar, Bangalore (IN); Rishabh Jha, Bangalore (IN); Kaustubh Bhoyar, Nagpur (IN); Vikraman Sridharan, Thiruvanmiyur (IN)

(21) Appl. No.: 14/500,702

(22) Filed: Sep. 29, 2014

(30) Foreign Application Priority Data
Oct. 1, 2013 (IN) 4463/CHE/2013

(51) Int. Cl. G06Q 30/02; G06Q 20/38

(52) U.S. Cl. CPC G06Q 30/0222; G06Q 20/38; G06Q 30/0238; G06Q 30/0226
USPC 705/14.23; 705/39

(57) ABSTRACT

An in-store customer engagement system is provided. The system includes a retail processing device located in a store, wherein the retail processing device is configured to process transactions of a customer. The system also includes a customer registration device configured to receive customer data from the customer and to register the customer with a customer relationship management (CRM) application of the store. The system further includes a first server communicatively coupled to the retail processing device and to the customer registration device wherein the first server is configured to transmit the customer data to the retail processing device upon registration of the customer with the customer relationship management application.

### BACKGROUND

In retail industry, retailers often operate customer loyalty programs to reward selected customers such as customers that frequently shop at the retailer's store and/or those customers which spend substantial amounts of money at the retailer's store. Such loyalty programs can offer discounts, customized offers etc. as rewards to selected customers based on their previous purchase data.

The retailers typically maintain a data of customer such as demographic data and purchase patterns of the customer over a period of time and so forth. In some stores, cashiers processing transactions of customers at one or more point-of-sale (POS) devices in the store are assigned to receive and maintain customer data. The cashiers typically make data entries for registration of the customer with a loyalty program of the store while processing the transactions of the customer. However, this may result in erroneous data entries by the cashiers.

Moreover, additional tasks of data entry performed by the cashiers may lead to long customer queues at the POS devices as the cashier may spend substantial time in entering the customer details for registration of customer with the loyalty program. Such delays and long customer queues can lead to customer dissatisfaction. Also, the data entry errors can result in errors in generating customized rewards for the customers. Moreover, incorrect contact details (such as contact number, email etc.) of the customers can lead to failure of campaigns of retailers as such campaigns may not reach the intended customers.

### SUMMARY

The following summary is illustrative only and is not intended to be in any way limiting. In addition to the illustrative aspects, embodiments, and features described above, further aspects, embodiments, and features will become apparent by reference to the drawings and the following detailed description.

According to some examples of the present disclosure, an in-store customer engagement system is provided. The in-store customer engagement system includes a retail processing device located in a store. The retail processing device is configured to process transactions of a customer. The system also includes a customer registration device configured to receive customer data from the customer and to register the customer with a customer relationship management (CRM) application of the store. The system further includes a first server communicatively coupled to the retail processing device and to the customer registration device. The first server is configured to transmit the customer data to the retail processing device upon registration of the customer with the customer relationship management application.

According to additional examples of the present disclosure, a computer-implemented method for managing in-store customer engagements is provided. The method includes processing purchase transactions of a customer at a retail processing device. The method also includes receiving customer data from the customer via a customer registration device and sending the received customer data to a customer relationship management module to register the customer with a customer relationship management application. The method further includes transmitting the customer data to the retail processing device upon successful registration of the customer with the customer engagement application.

According to still further examples of the present disclosure, a computer-implemented method for managing in-store customer engagements is provided. The method includes providing a customer registration device at a retail counter of a store. The method also includes processing purchase transactions of a customer at the retail counter using a retail processing device and registering the customer with a customer relationship management application using the customer registration device. The method further includes transmitting customer registration data to the retail processing device upon successful registration of the customer with the customer relationship management application.

### BRIEF DESCRIPTION OF THE FIGURES

FIG. 1 is a schematic diagram illustrating components of an example system for managing in-store customer engagement.

FIG. 2 is a schematic diagram illustrating functional components of another example system for managing in-store customer engagements.

FIG. 3 illustrates an example implementation of the system of FIG. 1 for managing in-store customer engagements of a client.

FIG. 4 is an illustration of an example process for managing in-store customer engagements of a client.

FIG. 5 illustrates an example screen shot of a home screen of the system of FIG. 1 in accordance with aspects of the present technique.

FIG. 6 illustrates an example screen shot of a customer registration screen of the system of FIG. 1 in accordance with aspects of the present technique.

FIG. 7 shows an example screen shot of an intimation screen that appears on one or more POS devices of a retail store to indicate arrival of a registered customer in the store in accordance with aspects of the present technique.

FIG. 8 shows an example screen shot of a transactional screen to process transactions related to purchases made by a customer in a store in accordance with aspects of the present technique.

FIG. 9 is a block diagram illustrating an example computing device that is arranged for managing in-store customer engagement.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be used, and other changes may be made, without departing from the spirit or scope of the subject matter presented herein. It will be readily understood that the aspects of the present disclosure, as generally described herein, and illustrated in the Figures, can be arranged, substituted, combined, separated, and designed in a wide variety of different configurations, all of which are explicitly contemplated herein.

Example embodiments of the present disclosure are generally directed to techniques for managing in-store customer engagements such as in retail environment. Some example embodiments include techniques for real-time registration of customers in a retail store. The registration data is provided by the customer using a customer registration device in the store. Such customer registration data is utilized for enrolling the customers with certain loyalty programs of the retail store. Further, the data is automatically transmitted to one or more point-of-sale (POS) devices of the store, sale kiosks etc. within the store.

In some embodiments, the registration data is associated with one or more invoices of the respective customers at the POS devices thereby substantially decreasing the number of anonymous bills generated in the store. The present technique substantially reduces cash counter queues as a cashier on the POS devices are not required to register the customers while processing the purchases of each customer. Moreover, the techniques also reduce incorrect entry of the customer registration data.

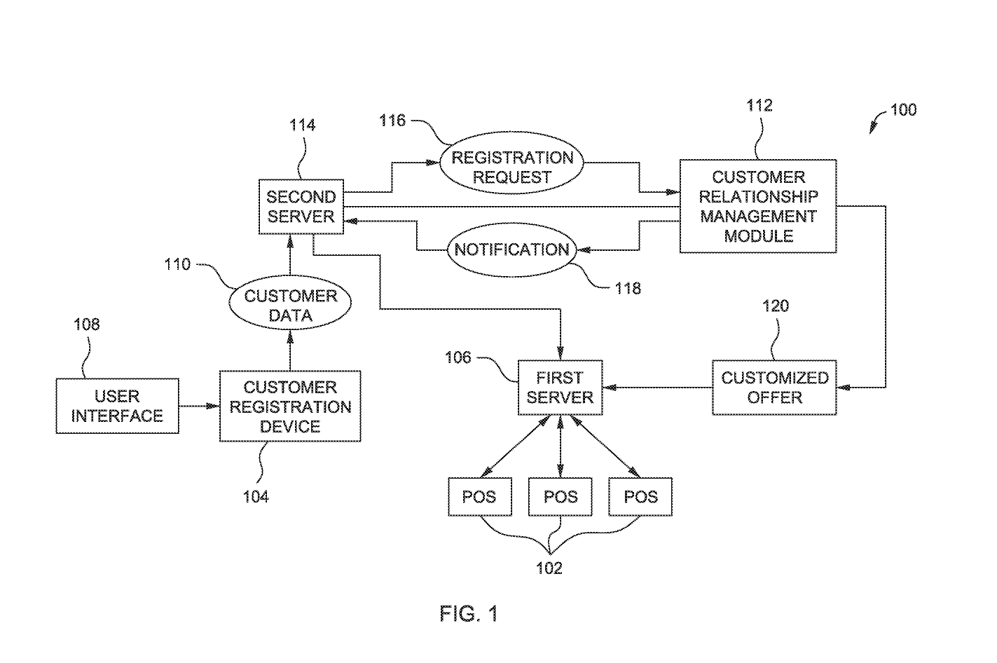

FIG. 1 is a schematic diagram illustrating functional components of an example system 100 for managing in-store customer engagements of a client arranged in accordance with at least some embodiments of the present disclosure. The system 100 includes at least one retail processing device such as a point of sale (POS) device (generally represented by reference numeral 102), a customer registration device 104, and a first server 106. The point of sale (POS) device 102 is located in a store and is configured to process transactions of a customer in the store. For example, the POS device 102 may comprise a cash register with a scanning station for the scanning of barcodes on the goods, or other means for registering the goods, e.g. a keyboard, keypad or other input means for manually inputting prices and/or product IDs, means for registering product information stored on a microchip, etc. In certain examples, the retail processing device 102 may include a tablet computer, a mobile communication device, smart phones, or other devices that can be accessed by operators of the store to process purchase transactions of the customers. Such devices can also be used by the operators for other operations such as viewing customer data, managing the store inventor and accessing a CRM system of the store, among others.

The customer registration device 104 is configured to receive customer data 110 from the customer via a user interface 108 and to register the customer with a customer relationship management (CRM) application of the store. For example, the customer may enter the customer data 110 directly into the customer registration device 104 without interacting with a sales assistant, e.g. via a keypad, touch screen, speech recognition, or the like. The system 100 includes a customer relationship management module 112 to execute the CRM application. In certain embodiments, the customer relationship management (CRM) module 112 is a cloud-based resource.

In certain embodiments, the customer registration device 104 is configured to receive the customer data 110 from the customer via a web based application. In certain other embodiments, the customer data 110 may be received using a mobile application available on a mobile communication device of the customer. Examples of the customer registration device 104 include, but are not limited to, a tablet computer, a personal digital assistant (PDA), a personal computer, a smart phone, a kiosk, a smart watch, or combinations thereof. In some examples, a mobile communication device of the customer functions as the customer registration device and facilitates the registration of the customer with the CRM application.

Examples of the customer data 110 include, but are not limited to, name of the customer, age of the customer, contact telephone number of the customer, address of the customer, email address of the customer, demographic data of the customer, preferences of the customer, profile of the customer on a social networking site, or combinations thereof.

The first server 106 is communicatively coupled to the POS device 102 and to the customer registration device 104. In the illustrated embodiment, the first server 106 is configured to transmit customer data 110 received using the customer registration device 104 to the POS device 102 upon registration of the customer with the customer relationship management application. In some examples, the first server 106 is configured to communicate with the POS device 102 using a communication protocol such as an extensible messaging and presence protocol (XMPP), a web socket, a hypertext transfer protocol (HTTP) socket. Other suitable protocols may be used. In one embodiment, the first server 106 may be co-located with the POS device 102. Alternately, the first server 106 may be placed at a location different than the location of the POS device 102.

The system 100 further includes a second server 114 communicatively coupled to the customer registration device 104, the customer relationship management module 112, and the first server 106. The second server 114 is configured to receive the customer data 110 from the customer registration device 104 and to send a registration request 116 and the customer data 110 to the customer relationship management module 112 to register the customer with the customer relationship management application. The second server 114 is further configured to receive a notification 118 that is indicative of successful registration of the customer with the customer relationship management (CRM) application.

The second server 114 is further configured to transmit the customer data 110 of the registered customer to the POS device 102 upon successful registration of the customer with the CRM application. In some embodiments, the customer registration device 104 is configured to identify the location of the customer via a location detection system. For example, the customer registration device 104 can identify the location through geo location, a unique uniform resource locator (URL)/quick response (QR) Code, a hardware device providing location specific information, a global positioning system (GPS), a wireless identifier, or combinations thereof. In some embodiments, the POS device 102 is identified by the first server 106 using a POS identification number. In some example embodiments, the POS device 102 is identified by the first server 106 with the POS identification number using a look-up table, a rule-based system, an identification algorithm, or combinations thereof.

In some examples, the customer data 110 is transmitted to one or more POS devices 102. The number of the POS devices 102 that receive the customer data 110 may be user configurable. Moreover, each of the POS devices 102 are identified using assigned identification numbers. In one example embodiment, the customer data 110 received by the POS device 102 is associated with one or more invoices generated by the POS device 102 corresponding to the transactions of the customer. The tagging of the customer data 110 with the invoices can substantially reduce number of anonymous bills generated in the store.

The customer relationship management module 112 is configured to analyze the customer data 110 and transactional data of the respective customer to select one or more applicable rules from a rule engine to generate one or more customized offers 120 for the customer. The first server 108 is configured to receive the one or more customized offers 120 from the customer relationship management module 112 and to transmit the one or more customized offers 120 to the POS device 102. Examples of the one or more customized offers 120 generated by the customer event management module 112 include, but are not limited to, product offers, discount coupons, award points, or combinations thereof. The respective customer can redeem the one or more customized offers 120 at the POS device 102.

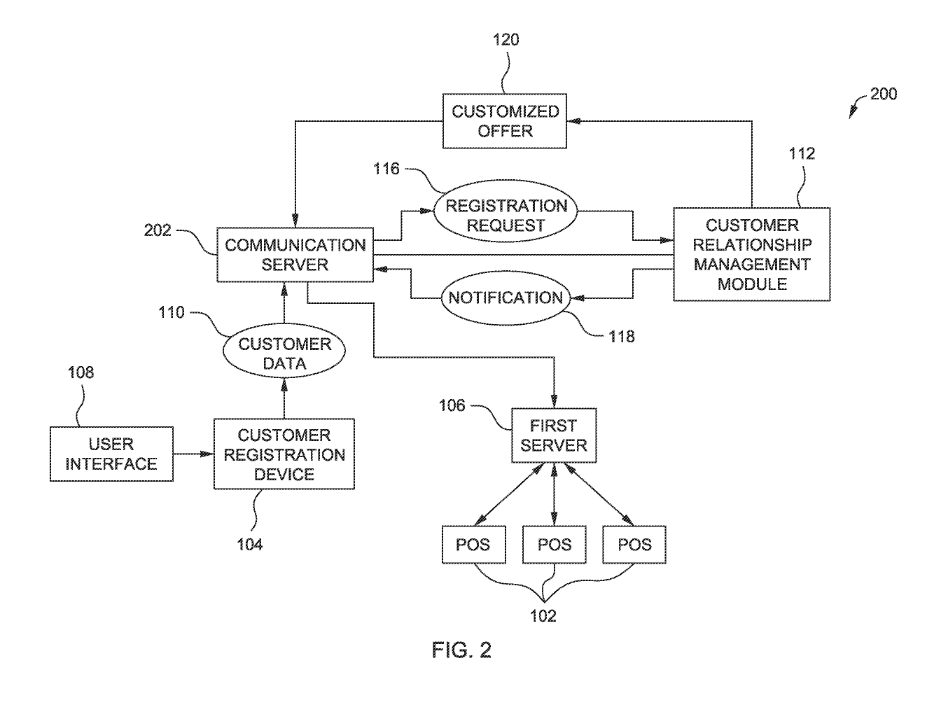

Referring now to FIG. 2, a schematic diagram illustrating functional components of another example system 200 for managing in-store customer engagements is provided. As with the system 100 of FIG. 1, the system 200 includes the POS device 102, the customer registration device 104 and the customer relationship management module 112. As explained above, the POS device 102 is located in a store and is configured to process transactions of a customer. The customer registration device 104 receives the customer data 110 from the customer and registers the customer with the customer relationship management (CRM) application of the store. In some embodiments, a mobile communication device of a customer is used to receive the customer data 110 from the customer and to register the customer with the CRM application.

In this example embodiment, the system 200 includes a communication server 202 to facilitate the customer registration of one or more customers with the CRM application and to transmit the customer data to one or more POS devices of the store. In operation, the communication server 202 receives the customer data 110 from the customer registration device 104 and sends the registration request 116 and the customer data 110 to the customer relationship management module 112 to register the customer with the customer relationship management application. The communication server 202 receives a notification 118 upon successful registration of the customer with the customer relationship management (CRM) application and subsequently transmits the customer data 110 of the registered customer to the POS device 102. The communication server 202 is configured to communicate with the POS device 102 using a communication protocol such as an extensible messaging and presence protocol (XMPP), a web socket, a hypertext transfer protocol (HTTP) socket.

In some examples, the customer relationship management module 112 is configured to analyze the customer data 110 and the transactional data of the respective customer to select one or more applicable rules from a rule engine to generate the one or more customized offers 120 for the customer and to transmit the one or more customized offers 120 to the communication server 202. The communication server 202 transmits the received one or more customized offers 120 to the POS device 102 and the customer can redeem the one or more customized offers 120 at the POS device 102.

It should be noted that the above arrangement of the components is purely illustrative and a variety of other arrangements and components may be envisaged. The present technique may include combination of servers to facilitate registration of customers and transmission of customer data to the POS devices for the in-store customer engagement system. In some example configurations, a variety of customer registration devices may be used to facilitate registration of the customer with the CRM application.

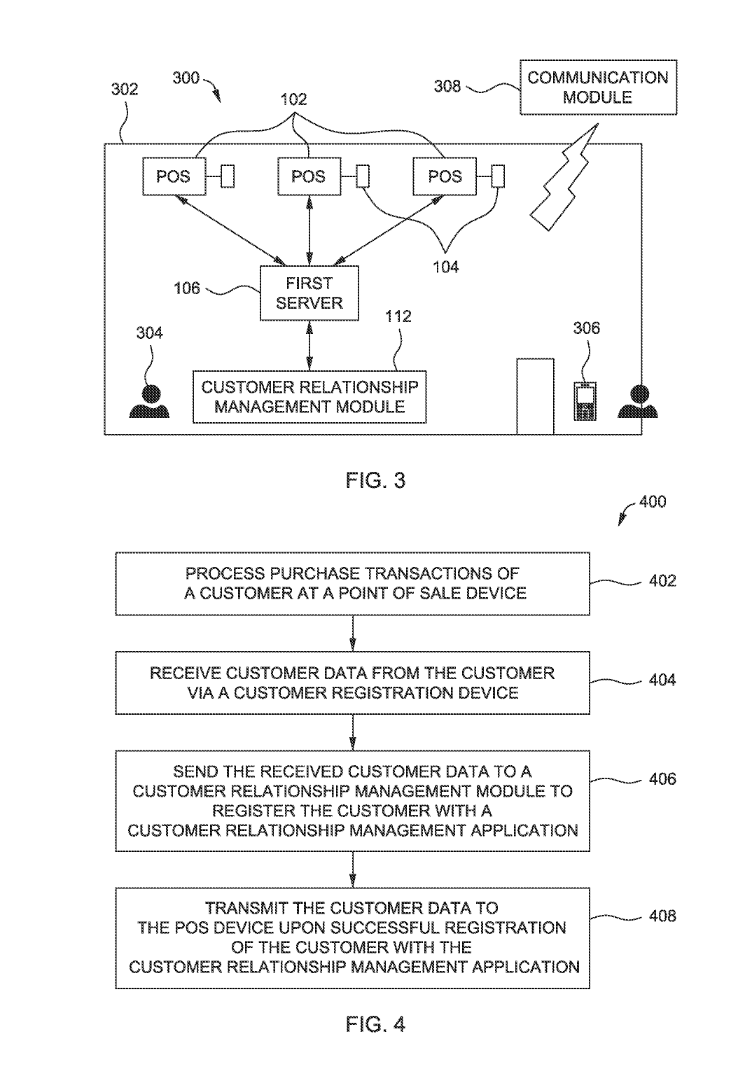

Referring now to FIG. 3, an example implementation 300 of the system 100 of FIG. 1 for managing in-store customer engagements of a client is provided. The system 300 includes the one or more POS devices generally represented by reference numeral 102 located at various locations in a store 302. The one or more POS devices 102 are configured to process transactions of one or more customers such as represented by reference numerals 304. In the illustrated embodiment, the store 302 includes one or more customer registration devices 104 configured to receive the customer data 110 of the customers 304.

As can be seen, the customer registration devices 104 may be accessible by the customers 304 at the one or more POS devices 102. However, the customer registrations devices 104 may be independent of the one or more POS devices. For example, one or more kiosks may be provided in the store 302 and may be used by the customers 304 to provide customer data. In some embodiments, mobile communications devices 306 such as smart phones are used by the customers 304 to provide the customer data 110.

The system 300 also includes the first server 106 configured to transmit the customer data 110 to the POS device 102 upon registration of the customer with the customer relationship management application executed by the customer relationship management module 112.

The system 300 further includes one or more communication modules 308 located in the store 302, and optionally at a remote location, to communicate with the customers 304 through a communication device 306 of the customer 304. Example of the communication device 306 include, but are not limited to, a smart phone, a personal digital assistant (PDA), a smart watch, a tablet computer or combinations thereof. The communication module 308 communicates with the communication device 306 via wired or wireless network that communicatively links the customer 304 with the customer relationship management module 112. For example, the communication modules 308 may operate via telephone lines, cable lines, Ethernet lines, optical lines, satellite communications, radio frequency (RF) communications, or combinations thereof.

In some embodiments, wireless communications links may be used that are based on any suitable wireless communications technology, e.g. radio-based communication or communication using other electromagnetic radiation, e.g. infrared radiation. For example, the communications links are short-range communications links operating in a sufficient range around the transaction system. Examples of known communications standards for short range wireless communications comprise Bluetooth and IrDA (Infrared Data Association).

In operation, as the customer 304 enters the store 302, the communication module 308 detects the presence of the communication device 306 of the customer 304. Upon detection of the presence of the communication device 306, the communication module 308 communicates with the communication device 306 of the customer 304 and sends a message to the communication device 306. The message may include a web link for registering the customer 304 with a loyalty program of the store. The customer 304 can enter the required customer data 110 using the web link through the communication device 306. Such customer data 110 is transmitted by the communication module 306 to the first server 106. The first server 106 subsequently forwards the customer data 110 to the customer relationship management module 112 for registration of the customer 304 with a CRM application.

Moreover, a message is sent to the one or more POS devices 102 upon successful registration of the customer 304 with the CRM application. The customer data 110 is also transmitted to the one or more POS devices 102 and can be associated with one or more invoices generated at the POS devices for transactions of the customer 304. In some examples, the customer data 110 and a notification of successful registration is also sent to the communication device 306.

In some embodiments, when it is determined that the customer 304 is a registered customer with the CRM application, the communication module 308 sends a message (e.g., a pop-up message) to the POS devices 102 located at various locations in the store 302 to inform arrival of the particular customer. The customer data stored for such registered customers 304 is automatically associated with invoices generated for any transactions made by the customers 304. In some example embodiments, customized offers 120 for the customers 304 may be transmitted from the customer relationship management module 112 to the communication devices 306 of the respective customers 304.

Referring now to FIG. 4 an illustration of an example process 400 for managing in-store customer engagement is provided. At block 402, the purchase transactions of a customer are processed at a point of sale device.

At block 404, the customer data is received from the customer via a customer registration device. In one embodiment, the customer registration device is provided at the point of sale counter of the store. In other embodiments, the customer registration devices are provided at various locations within the store. In another embodiment, a communication device of the customer functions as the customer registration device. Examples of the customer data include, but are not limited to, name of the customer, age of the customer, contact telephone number of the customer, address of the customer, email address of the customer, demographic data of the customer, likes/preferences of the customer or combinations thereof.

Examples of the customer registration device include, but are not limited to, a tablet computer, a personal digital assistant (PDA), a personal computer, a smart phone, a kiosk, or combinations thereof. In one example embodiment, the customer data is associated to one or more invoices generated at the POS device, wherein the one or more invoices correspond to the purchase transactions of the customer.

At block 406, the received customer data is sent to a customer relationship management module to register the customer with a customer relationship management application of the store. The customer relationship management (CRM) module is configured to execute the CRM application. Further, the customer relationship management module is configured to analyze the customer data and the transactional data of the respective customer to select one or more applicable rules from a rule engine to generate the one or more customized offers for the customer and to transmit the one or more customized offers to the first server. Examples of the one or more customized offers generated by the customer event management module include, but are not limited to, product offers, discount coupons, award points, or combinations thereof.

At block 408, the customer data is transmitted to the POS device upon successful registration of the customer with the customer relationship management application. In one example embodiment, a first server receives the customer data from the customer registration device and the received customer data is transmitted from the first server to the POS device. In some examples, the first server communicates with the POS device 102 using a communication protocol such as an extensible messaging and presence protocol (XMPP), a web socket, a hypertext transfer protocol (HTTP) socket. In some embodiments, the one or more customized offers are transmitted to the POS device via the first server and the customer redeems the one or more customized offers at the POS device.

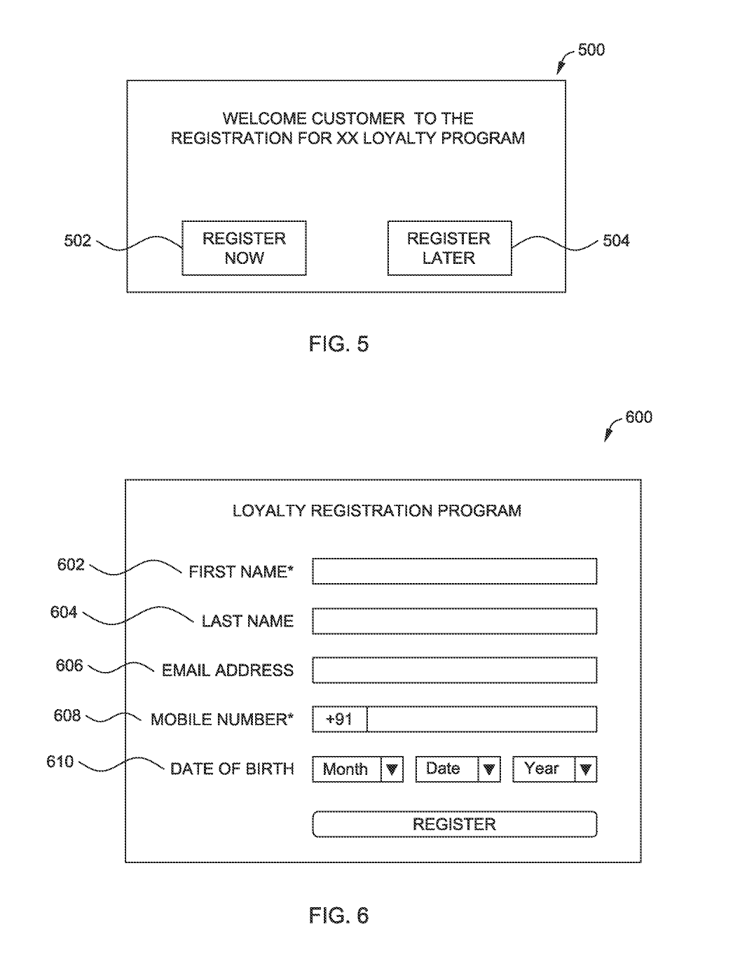

FIGS. 5-8 illustrate example screen shots for the system of FIG. 1. FIG. 5 shows an example screen shot 500 of a home screen for the system of FIG. 1. In the illustrated embodiment, the home screen 500 provides an option for a customer to register with a CRM application such as a loyalty program of the store. In one example embodiment, the home screen 500 is accessible by the customer on the one or more POS devices located at various locations in the store. In another example embodiment, the home screen shot 500 is displayed on a personal communication device of the customer as the customer enters the store. As can be seen, the home screen 500 provides options to the customer like “REGISTER NOW” or “REGISTER LATER” represented by reference numerals 502 and 504 respectively. The customer can proceed with the registration at a particular time using the option “REGISTER NOW”. Alternately, the customer can select the option “REGISTER LATER” to register for the loyalty program at a later point in time.

FIG. 6 shows an example screen shot 600 of a customer registration screen for the system of FIG. 1. The customer registration screen 600 is utilized by the customer to enter the customer data for registration with a CRM application such as a loyalty program of the store. In one example, the customer registration screen includes a web-based application to facilitate the customer registration with the CRM application. In one example embodiment, the customer registration screen 600 is accessed by the customer using one or more customer registration devices such as kiosks, tablet computers etc. located at various locations in the store. In another example embodiment, the customer registration screen 600 is available to the customer via their respective personal communication devices such as mobile phones of the customer upon entering the store.

The customer registration screen 600 includes various fields regarding details of customer required for registering with the loyalty program of the store. In the illustrated embodiment, the customer details include, but are not limited to, first name of the customer 602, last name of the customer 604, email address of the customer 606, mobile number of the customer 608 and date of birth of the customer 610. In certain embodiments, some of the customer detail fields can be set to be mandatory while others may be optional. It should be noted that the fields shown in the customer registration screen 600 are for illustrative purposes only. Depending upon the registration requirements of CRM applications of a store, there can be different fields available to the customers.

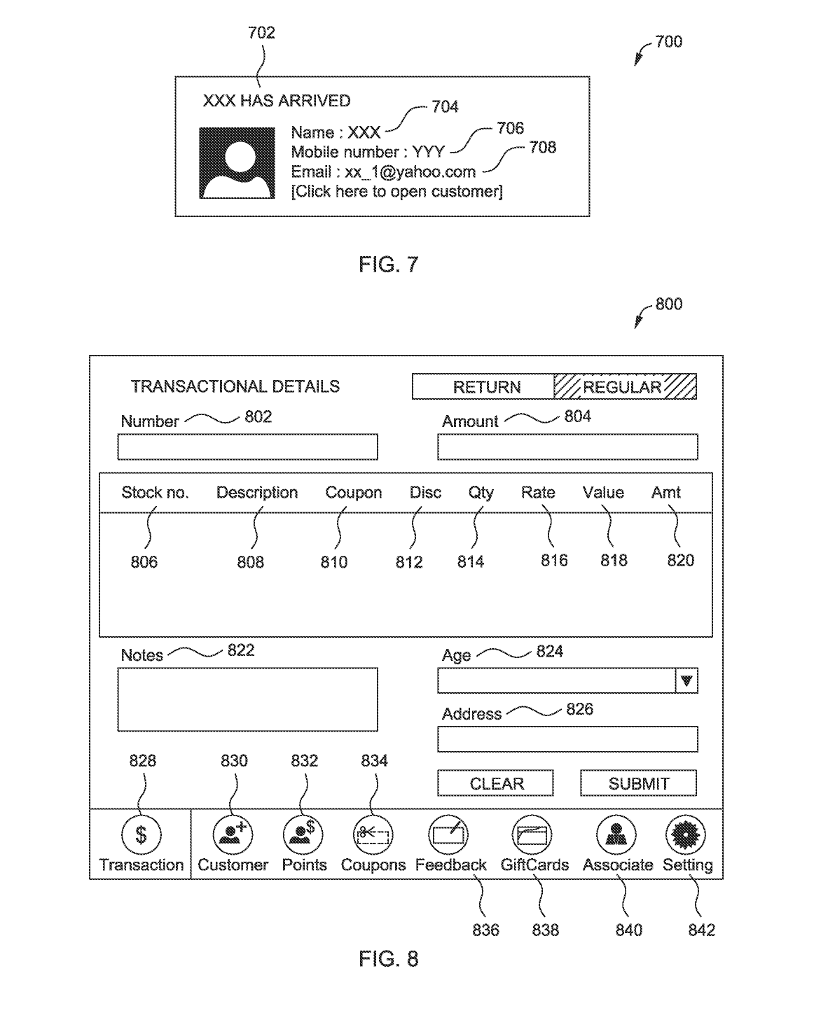

FIG. 7 shows an example screen shot 700 of an intimation screen that appears on one or more POS devices of a retail store to indicate arrival of a registered customer in the store. As a registered customer enters the store, a communication module located in the store, and optionally at a remote location detects a communication device such as a mobile phone of the registered customer. Upon detection of communication device of the registered customer the communication module triggers display of the pop-up intimation screen 700 to the one or more POS devices located in the store to indicate arrival of the particular customer.

As can be seen, the intimation screen 700 includes the intimation of the arrival of the customer generally represented by reference numeral 702. The screen 700 also includes other details such as name of the customer 704, mobile number of the customer 706, email address of the customer 708, and so forth.

FIG. 8 shows an example screen shot 800 for a transactional screen to process transactions related to purchase made by a customer in a store. As can be seen, the transactional screen 800 includes a plurality of fields to receive the transactional details of the customer. In addition, the screen 800 can display other customer data that is automatically available from the details provided by the customer upon registration with a CRM application of the store. In the illustrated embodiment, the transactional data corresponding to one or more purchases made by the customer at the store are entered using the screen 800 and these transactional details are automatically associated with the existing customer data.

The various fields entered for one or more transactions of the customer include, but are not limited to, a transaction number 802, a transaction amount 804, a stock number of the item purchased 806, description of the item purchased 808, a purchase coupon 810, a discount 812, quantity of the items purchased 814, a rate of the item purchased 816, a value of the purchased items 818, a total amount 820 and notes entered by an operator 822.

Moreover, fields regarding customer data entered for the registration of the customer with the CRM application of include, but are not limited to, age of the customer 824, and address of the customer 826. The screen 800 further includes fields related to transactions, addition of a customer, loyalty points of the customer, available coupons, feedback, gift cards, associates and/or operators and settings shown by reference numerals 828, 830, 832, 834, 836, 838, 840 and 842 respectively.

As can be seen, the various fields available may be used by an operator of the system for processing transactions of a customer. For example, the operator may facilitate redemption of the available coupons 834 while the transactions of the customer are processed at the POS device. In some embodiments, the customer data provided by the customer for registration with the CRM application may be associated with one or more invoices generated by the operator for transactions of the customer. For example, based on amount of transaction made by the customer, the loyalty points 832 may be updated by the operator.

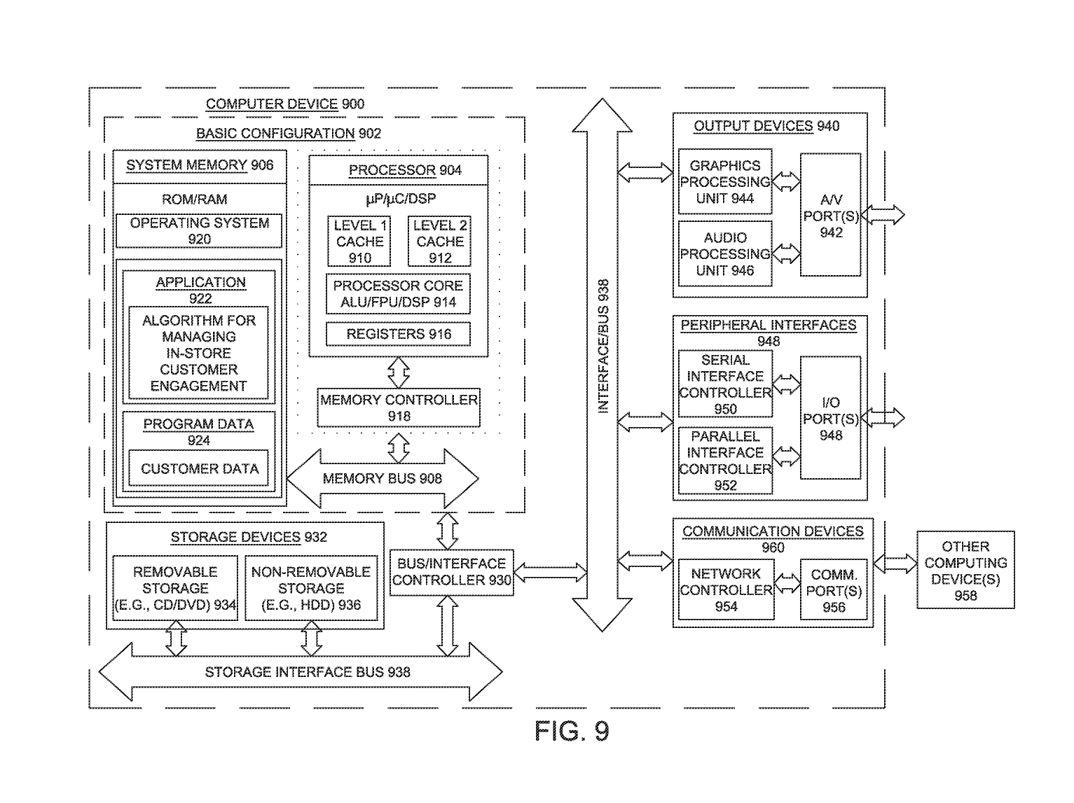

FIG. 9 is a block diagram illustrating an example computing device 900 that is arranged for managing in-store customer engagement with at least some embodiments of the present disclosure. In a very basic configuration 902, the computing device 900 typically includes one or more processors 904 and a system memory 906. A memory bus 908 may be used for communicating between processor 904 and system memory 906. The processor 904 includes a multi-core processor.

Depending on the desired configuration, processor 904 may be of any type including but not limited to a microprocessor (μP), a microcontroller (μC), a digital signal processor (DSP), or any combination thereof. Processor 904 may include one more levels of caching, such as a level one cache 910 and a level two cache 912, two or more processor cores 914, and registers 916. An example processor core 914 may include an arithmetic logic unit (ALU), a floating point unit (FPU), a digital signal processor core (DSP Core), or any combination thereof. An example memory controller 918 may also be used with processor 904, or in some implementations memory controller 918 may be an internal part of processor 904.

Depending on the desired configuration, system memory 906 may be of any type including but not limited to volatile memory (such as RAM), non-volatile memory (such as ROM, flash memory, etc.) or any combination thereof. System memory 906 may include an operating system 920, one or more applications 922, and program data 924. In some embodiments, application 922 may be arranged to operate with program data 924 on operating system 920. This described basic configuration 902 is illustrated in FIG. 9 by those components within the inner dashed line. Application 922 may include algorithm for managing in-store customer engagement. Program data 924 may include the customer data and/or transactional data of a plurality of customers.

Computing device 900 may have additional features or functionality, and additional interfaces to facilitate communications between basic configuration 902 and any required devices and interfaces. For example, a bus/interface controller 930 may be used to facilitate communications between basic configuration 902 and one or more data storage devices 932 via a storage interface bus 934. Data storage devices 932 may be removable storage devices 936, non-removable storage devices 938, or a combination thereof.

Examples of removable storage and non-removable storage devices include magnetic disk devices such as flexible disk drives and hard-disk drives (HDD), optical disk drives such as compact disk (CD) drives or digital versatile disk (DVD) drives, solid state drives (SSD), and tape drives to name a few. Example computer storage media may include volatile and nonvolatile, removable and non-removable media implemented in any method or technology for storage of information, such as computer readable instructions, data structures, program modules, or other data.

System memory 906, removable storage devices 936 and non-removable storage devices 938 are examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which may be used to store the desired information and which may be accessed by computing device 900. Any such computer storage media may be part of computing device 900.

Computing device 900 may also include an interface bus 940 for facilitating communication from various interface devices (e.g., output devices 942, peripheral interfaces 944, and communication devices 946) to basic configuration 902 via bus/interface controller 930. Example output devices 942 include a graphics processing unit 948 and an audio processing unit 950, which may be configured to communicate to various external devices such as a display or speakers via one or more A/V ports 952.

Example peripheral interfaces 944 include a serial interface controller 954 or a parallel interface controller 956, which may be configured to communicate with external devices such as input devices (e.g., keyboard, mouse, pen, voice input device, touch input device, etc.) or other peripheral devices (e.g., printer, scanner, etc.) via one or more I/O ports 958. An example communication device 946 includes a network controller 960, which may be arranged to facilitate communications with one or more other computing devices 962 over a network communication link via one or more communication ports 964.

The network communication link may be one example of a communication media. Communication media may typically be embodied by computer readable instructions, data structures, program modules, or other data in a modulated data signal, such as a carrier wave or other transport mechanism, and may include any information delivery media. A “modulated data signal” may be a signal that has one or more of its characteristics set or changed in such a manner as to encode information in the signal. By way of example, and not limitation, communication media may include wired media such as a wired network or direct-wired connection, and wireless media such as acoustic, radio frequency (RF), microwave, infrared (IR) and other wireless media. The term computer readable media as used herein may include both storage media and communication media.

Computing device 900 may be implemented as a portion of a small-form factor portable (or mobile) electronic device such as a cell phone, a personal data assistant (PDA), a personal media player device, a wireless web-watch device, a personal headset device, an application specific device, or a hybrid device that include any of the above functions. Computing device 900 may also be implemented as a personal computer including both laptop computer and non-laptop computer configurations.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims.

The present disclosure is to be limited only by the terms of the appended claims, along with the full scope of equivalents to which such claims are entitled. It is to be understood that this disclosure is not limited to particular methods, reagents, compounds compositions or biological systems, which can, of course, vary. It is also to be understood that the terminology used herein is for the purpose of describing particular embodiments only, and is not intended to be limiting.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present.

For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.).

It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc.

As will also be understood by one skilled in the art all language such as “up to,” “at least,” “greater than,” “less than,” and the like include the number recited and refer to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

What is claimed is:

1. An in-store customer engagement system, comprising:
a retail processing device located in a store, wherein the retail processing device is configured to process transactions of a customer;
a customer registration device configured to receive customer data from the customer and to register the customer with a customer relationship management (CRM) application of the store; and
a first server communicatively coupled to the retail processing device and to the customer registration device, wherein the server is configured to transmit the customer data to the retail processing device upon registration of the customer with the customer relationship management application.

2. The in-store customer engagement system of claim 1, wherein the retail processing device comprises a point of sale (POS) device, a tablet computer, a mobile communication device, a mobile POS device, a clienteling device, or combinations thereof.

3. The in-store customer engagement system of claim 1, wherein the customer data received by the retail processing device is associated with one or more invoices generated by the retail processing device, and wherein the one or more invoice correspond to the transactions of the customer.

4. The in-store customer engagement system of claim 1, further comprising a customer relationship management (CRM) module configured to execute the CRM application.

5. The in-store customer engagement system of claim 4, further comprising a second server communicatively coupled to the customer registration device, the customer relationship management module and the first server, wherein the second server is configured to:
receive customer data from the customer registration device;
send a registration request and the customer data to the customer relationship management module to register the customer with the customer relationship management application;
receive a notification indicative of successful registration of the customer with the customer relationship management (CRM) application; and
transmit the customer data of the registered customer to the first server communicatively coupled to the retail processing device.

6. The in-store customer engagement system of claim 1, wherein the customer registration device is configured to receive customer data from the customer via a web based application.

7. The in-store customer engagement system of claim 1, wherein the customer registration device comprises a tablet computer, a personal digital assistant (PDA), a personal computer, a kiosk, a smart phone, or combinations thereof.

8. The in-store customer engagement system of claim 7, wherein the customer registration device is configured to identify the location of the customer via a location detection system.

9. The in-store customer engagement system of claim 1, wherein the customer data comprises name of the customer, age of the customer, contact telephone number of the customer, address of the customer, email address of the customer, preferences of customer, demographic data of customer, or combinations thereof.

10. The in-store customer engagement system of claim 1, wherein the first server communicates with the retail processing device through a communication protocol.

11. The in-store customer engagement system of claim 10, wherein the communication protocol comprises an extensible messaging and presence protocol (XMPP), a web socket, a hypertext transfer protocol (HTTP) socket, or combinations thereof.

12. The in-store customer engagement system of claim 1, wherein the retail processing device is identified by the first server with a POS identification number using a look-up table, a rule-based system, an identification algorithm, or combinations thereof.

13. The in-store customer engagement system of claim 1, wherein the customer relationship management module is configured to generate one or more customized offers for the customer and to transmit the one or more customized offers to the first server.

14. The in-store customer engagement system of claim 13, wherein the first server is configured to transmit the received one or more customized offers to the POS device and wherein the customer can redeem the one or more customized offers at the POS device.

15. The in-store customer engagement system of claim 13, wherein the customer relationship management module is configured to analyze the customer data and transactional data of the respective customer to select one or more applicable rules from a rule engine to generate the one or more customized offers for the customer.

16. The system of claim 15, wherein the one or more customized offers generated by the customer event management module comprise product offers, discount coupons, award points, gift cards, or combinations thereof.

17. The system of claim 13, wherein customer relationship management module is a cloud-based resource.

18. A computer-implemented method for managing in-store customer engagements, the method comprising:
processing purchase transactions of a customer at a retail processing device;
receiving customer data from the customer via a customer registration device;
sending the received customer data to a customer relationship management module and to register the customer with a customer relationship management application; and
transmitting the customer data to the retail processing device upon successful registration of the customer with the customer engagement application.

19. The method of claim 18, wherein transmitting the customer data further comprises receiving the customer data by a first server and transmitting the received customer data from the first server to the retail processing device.

20. The method of claim 18, further comprising associating the customer data to one or more invoices generated at the retail processing device, wherein the one or more invoices correspond to the purchase transactions of the customer.

21. The method of claim 18, further comprising generating one or more customized offers for the customer and transmitting the one or more customized offers to the retail processing device.

22. The method of claim 21, further comprising redeeming the one or more customized offers at the retail processing device.

23. A computer-implemented method for managing in-store customer engagements, the method comprising:
providing a customer registration device at a retail counter of a store;
processing purchase transactions of a customer at the retail counter using a retail processing device;
registering the customer with a customer relationship management application using the customer registration device;
transmitting customer registration data to the retail processing device upon successful registration of the customer with the customer relationship management application.

24. The method of claim 23, further comprising associating the customer data to one or more invoices generated at the retail processing device, wherein the one or more invoices correspond to the purchase transactions of the customer

25. The method of claim 23, wherein the customer provides the registration data via the customer registration device while the purchase transactions of the customer are processed at the retail counter.

26. The method of claim 23, wherein the transmitting the customer registration data comprises receiving the customer registration data by a first server and transmitting the received customer data from the first server to the retail processing device.
